(19) United States
(12) Patent Application Publication
(10) Pub. No.: US 2014/0085906 A1
(43) Pub. Date: Mar. 27, 2014

(54) LIGHT FIXTURE ACCESSORY

(71) Applicant: Kory Keogan, Ottawa (CA)

(72) Inventor: Kory Keogan, Ottawa (CA)

(21) Appl. No.: 14/123,157

(22) PCT Filed: Jun. 4, 2012
(86) PCT No.: PCT/CA2012/000543

§ 371 Date: Nov. 29, 2013

(30) Foreign Application Priority Data
Jun. 7, 2011 (CA) 2742439

(51) Int. Cl. F21V 1/00

(52) U.S. Cl. CPC F21V 1/00
USPC 362/355

(57) ABSTRACT

A portable light fixture accessory for diffusing or redirecting the light emitted from a recessed light fixture is disclosed. The apparatus consists of a longitudinally extending connector having a first magnetic flat end and a second end attached to an element. The longitudinally extending connector may be pivotable in at least one direction.

This application claims priority to Canadian Patent No. 2,742,439 filed Jun. 7, 2011 entitled “LIGHT FIXTURE ACCESSORY” by Kory Keogan and to International Application No. PCT/C2012/000543 filed Jun. 4, 2012 entitled “LIGHT FIXTURE ACCESSORY” by Kory Keogan.

### FIELD

The present invention relates to commercial and residential light fixtures. More specifically, it relates to an apparatus that diffuses or redirects the light emitted from a recessed light fixture.

### BACKGROUND

Recessed lights are popular choices for both residential and commercial lighting applications. Recessed lights, also commonly known as “pot lights”, “can lights” or “downlights”, provide spotlight-type lighting while offering a low-profile arrangement that is well suited to applications when overhead clearance is limited or where highly visible light fixtures are undesirable.

However, recessed lights are quite directional. In other words, recessed lights typically emit light in one general direction. Therefore, recessed lights are not readily adapted to provide different lighting arrangements when the needs of a particular space change. For example, an arrangement of recessed lightning may be perfectly suited to a first tenant's furniture arrangement but be completely unsuitable to a second tenant's furniture arrangement. Further, a user may want to temporarily change the lighting arrangement of a particular room for an exhibition, party or other special event. Typical recessed lights do not provide this flexibility.

U.S. Pat. No. 5,154,509 to Wulfman et al. provides a magnetic track lighting system wherein magnetic features can be removed from a magnetized track system. However, Wulfman does not specifically contemplate a magnetic accessory that can be quickly installed on an existing recessed light to modify the light emitted from the recessed light. Further, Wulfman does not contemplate that the system is portable form one fixture to another,

U.S. Pat. No. 6,663,259 to Westfall provides a decorative frame for a light fixture, however this frame is purely ornamental and not specifically designed to diffuse light. Further, Westfall's light fixture is not specifically adapted for use in connection with a recessed light fixture.

U.S. Pat. No. 7,806,568 to Nielson provides a light fixture having a series of interchangeable decorative elements that are magnetically attached to the light fixture. However, these decorative elements are not adapted to diffuse light emitted from the light fixture and further are not contemplated for use in connection with a recessed light fixture.

CA 2,496,775 to Patterson et al. provides a system for directing light from a lamp that is capable of transmitting indirect light, direct light and luminous direct light, and is also removably positionable and decorative. However, Patterson does not disclose a reflecting device that is magnetically attachable to a recessed light.

CA 2,342,307 to Thomas et al, provides a trim plate having a flange and a representative frusto conical cup, which can be any decorative design and further has a water tight seal for a recessed lighting fixture. However, Thomas does not disclose a reflecting device that is magnetically attachable to a recessed light.

CA 2,431,946 to Ladstatter provides a neon light back reflector has means to achieve pot light-like or other ambiance-as-needed effect. However, Ladstatter achieves the effect by locating a reflector behind the light. Further, no magnetic attachment is taught by Ladstatter.

CA 2,196,946 to Pearce provides a kit of components for a decorative ceiling fan globe and blades. The globe has three-dimensional characters and is changeable. However the fan globe is not able to direct light and has only the functional features of a common regular light.

U.S. Pat. No. 7,874,706 to Carle Jr. provides an elongated downward shade of various materials for a recessed light fixture. However, Carle Jr. does not disclose a magnetic attachment, but rather a shade and flange or rim has an interference fit.

U.S. Pat. No. 7,618,166 to Truax et al. discloses a recessed light fixture that has a perforated flange that receives a plurality of magnets to secure a trim plate. However, Truax discloses a trim plate that is a component of a recessed light fixture, rather than a removable accessory that is contemplated for use in connection with a recessed light.

U.S. Pat. No. 7,198,391 to Rutchik discloses interchangeable collar attachment supporting decorative elements for a recessed light fixture. However, Rutchik does not disclose a recessed light accessory that is magnetically attached to a recessed light fixture for quick and easy repositioning.

U.S. Pat. No. 5,465,199 to Bray et al. discloses trim attachment to a recessed lamp housing. The attachment comprises regions having fingers and slot housings and provides rotational engagement of the trim attachment. However, Bray does not disclose a recessed light accessory that is magnetically attached to a recessed light fixture for quick and easy repositioning.

Accordingly, there is a need for an apparatus that can diffuse the light emitted from a recessed light and further can be quickly installed or removed from an existing recessed light.

### SUMMARY OF INVENTION

What is provided in at least one aspect is a portable apparatus for diffusing or redirecting the light emitted from a recessed light fixture, the apparatus having at least one longitudinally extending connector, the a least one longitudinally extending connector having a first flat end and a second end, the first flat end being magnetic, the connector being flexible in at least one direction, and an element connected to the second end of said at least one longitudinally extending connector, the element having a proximal surface and as distal surface, the element adapted to diffuse or redirect light.

### BRIEF DESCRIPTION OF THE DRAWINGS

Preferred embodiments will now be described in greater detail and will be better understood hen read in conjunction with the following drawings.

FIG. 1 is a lower perspective view of an apparatus in a first position in accordance with at least one embodiment.

FIG. 2 is a perspective view of the apparatus of FIG. 1 in a second position.

FIG. 3 is a lower perspective view of an apparatus in accordance with another embodiment.

FIG. 4 is a perspective view of an apparatus in accordance with another embodiment.

### DETAILED DESCRIPTION OF THE EMBODIMENTS

An apparatus is provided that is contemplated for use in residential and commercial lighting applications. The present apparatus is specifically contemplated for use in connection with recessed lights, however other types of light fixtures are also contemplated. The skilled person will recognize that the term “diffuser” also can contemplate the term “redirector” in the following disclosure.

A typical recessed light is mounted in a cavity provided in a ceiling. The ceiling may be a drywall ceiling (also known as wallboard, gypsum board. Sheetrock_, plasterboard or gyproc) or a dropped ceiling consisting of tiles or panels that are supported in a suspended metal framework, among other ceiling arrangements. In any case, an installation hole is cut in the ceiling material and a light fixture is internally mounted to an element of the ceiling-supporting structure adjacent to the hole, such as a metal beam or wooden ceiling rafter.

Typically, a slight gap results between the outer rim of the recessed light fixture and the edge of the installation hole. This gap is covered by a decorative flange that press fits into the installation hole. The decorative flange can be formed of a wide variety of materials but is typically formed from galvanized steel among other materials such as stainless steel, plastic and aluminum.

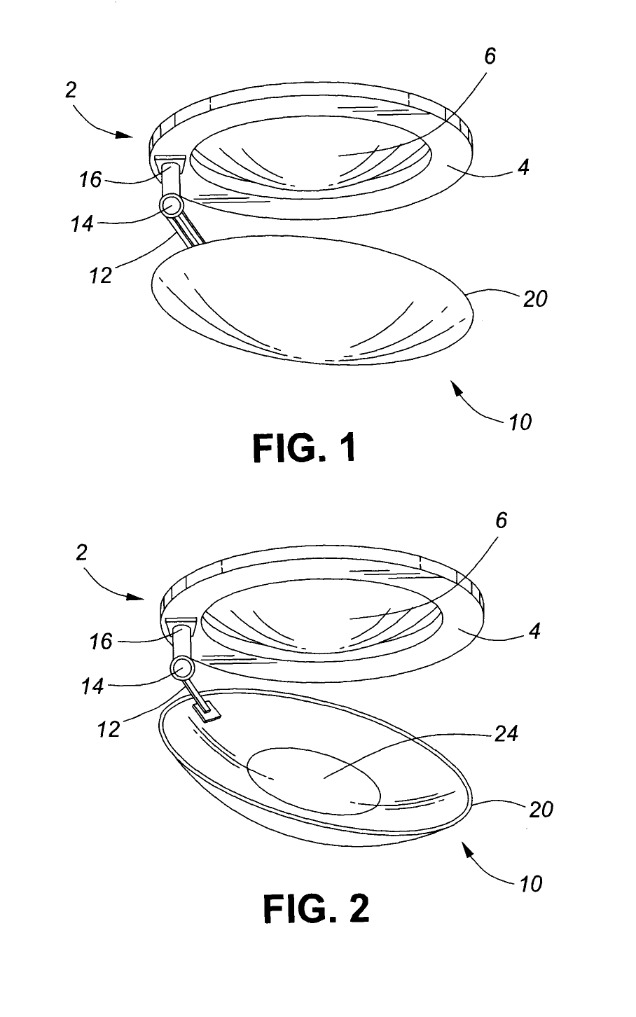

With reference to FIGS. 1 and 2 at least one embodiment of a light fixture accessory 10 adapted to diffuse the light emitted from a recessed light 2 is illustrated. As described above, recessed light 2 typically consists of a decorative flange 4 and an internally mounted light fixture 6.

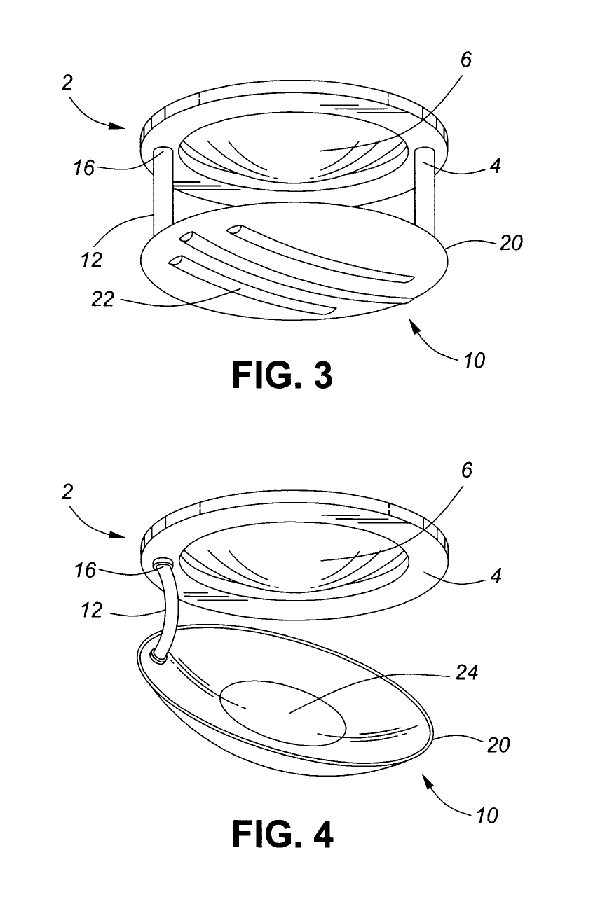

Light fixture accessory 10 has at least one longitudinally extending connector 12, in at least one embodiment, connector 12 is a shaft. As shown in FIG. 1, a single longitudinal extending connector may be used however two or more longitudinally extending connectors are also contemplated, as shown in FIG. 3. Connector 12 has a first end that abuts decorative flange 4 and a second end that is connected to an element 20, as will be discussed in greater detail below. First end of connector 12 has a magnetic surface 16 that is constructed and arranged to magnetically attach to decorative flange 4 when these two elements abut one another. Other means suitable for connecting first end of connector 12 to decorative flange 4 are also contemplated provided that the light fixture accessory 10 can be quickly and easily removed front the recessed light fixture.

In at least one embodiment connector 12 can be a flexible connector that is movable in all directions as shown in FIG. 4. In other embodiments connector 12 can have a hinge 14 located between the first end and the second end. Advantageously, hinge 14 may be located closer to the second end than the first end of connector 12, thereby providing element 20 with a larger degree of movement as will be understood by the skilled person. Hinge 14 provides at least one degree of freedom, however hinges that provide movement two or more degrees of freedom are also contemplated. It is further contemplated that hinge 14 could also function to provide up to 360 degrees of rotational movement.

Element 20 is connected to the second end of connector 12. In at least one embodiment, element 20 is a plate. Element 20 may be connected to connector 12 by any suitable means, including but riot limited to welding, integral forming, use of mechanical fasteners, use of adhesives, among other suitable connecting means that will be readily understood by the skilled person. Element has a proximal surface opposite recessed light 2 and an outwardly facing distal surface. It is contemplated that the proximal face of element 20 may be coated with a reflective material.

Element 20 can take a wide variety of plan shapes including but not limited to circular, square, rectangular, elliptical and triangular, among other shapes. Further, element 20 can be formed in the shape of common decorative designs such as Christmas trees, Santa heads, stars, hearts, balloon shapes, among other decorative designs. Element 20 can also be formed that it has a flat, convex or concave profile, depending on the needs of the application.

In at least one embodiment element 20 may include heat dissipating ribs 22 that facilitate heat transfer from the element to the ambient environment, as shown in FIG. 3. In at least one embodiment, it is contemplated that element 20 may include a window element that allows a small percentage of light emitted by the recessed light to pass through element 20. The window element can be a simple cut out portion of element 20, or alternatively can be a clear or opaque element formed of any suitable material. The window element can be formed in the shape of common decorative designs such as Christmas trees, Santa heads, stars, hearts, balloon shapes, among other decorative designs.

With reference to FIGS. 2 and 4, in at least one embodiment the proximal face of element 20 further contains a centrally located convex reflective surface 24 that is adapted to reflect light emitted from recessed light 2 in an outward direction.

Connector 12 and element 20 may be manufactured of any suitable material, provided that the material can withstand the heat emitted from a standard recessed light, including but not limited to certain plastics, wood, steel and aluminum among other materials that will be apparent to the skilled person. Further, connector 12 and element 20 can be manufactured by any suitable process including but not limited to forming and stamping among other suitable processes. The above-described embodiments of the present invention are meant to be illustrative of preferred embodiments of the present invention and are not intended to limit the scope of the present invention. Various modifications, which would be readily apparent to one skilled in the art, are intended to be within the scope of the present invention. The only limitations to the scope of the present invention are set out in the following appended claims.

We claim:

1. A portable apparatus for diffusing or redirecting the light emitted from a recessed light fixture, the apparatus comprising:
at least one longitudinally extending connector, said at least one longitudinally extending connector having a first flat end and a second end, said first flat end being magnetic, said connector being flexible in at least one direction; and
an element connected to said second end of said at least one longitudinally extending connector, said element having a proximal surface and a distal surface, said element adapted to diffuse or redirect light.

2. The apparatus of claim 1 wherein said at least one longitudinally extending connector has a hinge element located between said first end and said second end.

3. The apparatus of claim 2 wherein said hinge element is located closer to said second end than said first end.

4. The apparatus of claim 1 wherein said at least one longitudinally extending connector is a flexible connector.

5. The apparatus of any one of claims 1 to 4 wherein said element is flat.

6. The apparatus of any one of claims 1 to 5 wherein said element is concave.

7. The apparatus of any one of claims 1 to 6 wherein said element is convex.

8. The apparatus of any one of claims 1 to 7 wherein said element has a plan shape selected from the group consisting of circular, square, rectangular, triangular and ovoid.

9. The apparatus of any one of claims 1 to 8 wherein said element is manufactured from the group of materials consisting of: plastic, galvanized steel, stainless steel and aluminum.

10. The apparatus of claim 9 wherein said plastic is an opaque plastic.

11. The apparatus of any one of claims 1 to 10 wherein said element further comprises heat dissipating ribs.

12. The apparatus of any one of claims 1 to 11 wherein said proximal surface of said element is reflective.

13. The apparatus of any one of claims 1 to 12 wherein said proximal surface further comprises a centrally located convex reflective surface.

14. The apparatus of any one of claims 1 to 13 wherein said element further comprises a window element.

15. The apparatus of claim 14 wherein said window element is opaque.
